(19) United States
(12) Patent Application Publication
(10) Pub. No.: US 2015/0130940 A1
(43) Pub. Date: May 14, 2015

(54) APPARATUS FOR CONTROLLING DISPLAY OF VEHICLE CLUSTER AND METHOD THEREOF

(71) Applicant: Hyundai Motor Company, Seoul (KR)

(72) Inventor: Yun Sup ANN, Seoul (KR)

(21) Appl. No.: 14/313,674

(22) Filed: Jun. 24, 2014

(30) Foreign Application Priority Data
Nov. 12, 2013 (KR) 10-2013-0137096

(51) Int. Cl. B60R 1/00

(52) U.S. Cl. CPC B60R 1/00; B60R 2300/207; B60R 2300/802; B60R 2300/8066; B60R 2300/306
USPC 348/148

(57) ABSTRACT

An apparatus for controlling a display of a vehicle cluster includes a driving information collector configured to collect driving information of the vehicle. A visible region detector is configured to detect a visible region which is viewable to a driver. An image obtainer is configured to obtain various images. A display is configured to display the image obtained by the image obtainer on the visible region detected by the visible region detector. A controller is configured to control the image obtainer to obtain an image corresponding to the driving information collected by the driving information collector and control the display to display the image corresponding to the driving information collected by the driving information collector on the visible region detected by the visible region detector.

### CROSS-REFERENCE TO RELATED APPLICATION

This application is based on and claims the benefit of priority to Korean Patent Application No. 10-2013-0137096, filed on Nov. 12, 2013 in the Korean Intellectual Property Office, the disclosure of which is incorporated herein in its entirety by reference.

### TECHNICAL FIELD

The present disclosure relates to an apparatus for controlling a display of a vehicle cluster and a method thereof, and more particularly, to a technology detecting a cluster region (hereinafter, referred to as “a blind region”) which is blinded by a driver's hand and a steering wheel and then displaying a necessary image according to a driving state of a vehicle on a cluster region (hereinafter, referred to as “a visible region”) which is viewable to the driver except for the blind region.

### BACKGROUND

Typically, a front part of a driver seat of a vehicle is provided with a cluster providing all information related to a vehicle driving, operation state information of various apparatus such as an engine and the like, alert message and the like to a driver in a way displaying by characters or figures.

The cluster is installed with a plurality of gauges and indicators, for example, is provided with a speed meter measuring and indicating an instantaneous velocity of the vehicle, a trip meter, an integrating meter, a revolution per minute (RPM) speed meter indicating an RPM of the engine, a fuel gauge indicating a fuel residual amount, a cooling water thermometer indicating a temperature of a cooling water, and various gauges or indicators displaying an operating state and a warning state of a brake warning lamp, a seat belt warning lamp, a ABS warning lamp, a traction control system (TCS) warning lamp, and other sub-systems in the vehicle.

In the recent cluster, a use of a liquid crystal display (LCD) has been gradually increased to freely represent various information by graphics, phrases, or the like. In the past, the LCD of a twisted nematic (TN) type has been used, but in recent, the LCD of an In-plane switching (IPS) type or vertical alignment (VA) type has been gradually used.

In accordance with advancement of a representing function of the cluster, an infrared thermal image provided to the driver when using a night vision function, a rear side image provided to the driver when the vehicle is turned to a left or right direction, a rear image provided to driver when the vehicle is backed, and the like may be displayed.

However, since the cluster described above displays various image on a defined region without considering that the driver's eyes is blinded a hand of the driver and a steering wheel according to the turn, it may degrade visibility of the driver.

### SUMMARY OF THE DISCLOSURE

The present disclosure has been made to solve the above-mentioned problems occurring in the prior art while advantages achieved by the prior art are maintained intact.

An aspect of the present disclosure provides an apparatus for controlling a display of a vehicle cluster and a method thereof enabling a driver to view a necessary image according to a driving state of the vehicle at high visibility by detecting a cluster blind region which is blinded by a hand of a driver and a steering wheel and then displaying the necessary image according to the driving state of the vehicle on a visible region of the cluster which is viewable to the driver except for the cluster blind region.

According to an exemplary embodiment of the present disclosure, an apparatus for controlling a display of a vehicle cluster includes a driving information collector configured to collect driving information of the vehicle. A visible region detector is configured to detect a visible region which is viewable to a driver. An image obtainer is configured to obtain various images. A display is configured to display the image obtained by the image obtainer on the visible region detected by the visible region detector. A controller is configured to control the image obtainer to obtain an image corresponding to the driving information collected by the driving information collector and control the display to display the image corresponding to the driving information collected by the driving information collector on the visible region detected by the visible region detector.

According to another exemplary embodiment of the present disclosure, a method for controlling a display of a vehicle cluster includes collecting, by a driving information collector, driving information of a vehicle. A visible region, which is viewable to a driver, is detected by a visible region detector. An image corresponding to the collected driving information is obtained by an image obtainer. The obtained image is displayed on the detected visible region by a display.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of an apparatus for controlling a display of a vehicle cluster according to an exemplary embodiment of the present disclosure.

FIG. 2 is a detailed configuration diagram of a visible region detector according to an exemplary embodiment of the present disclosure.

FIG. 3 is a flow chart showing a method for controlling a display of a vehicle cluster according to an exemplary embodiment of the present disclosure.

FIGS. 4A and 4B are diagrams showing displaying results of the vehicle cluster according to an exemplary embodiment of the present disclosure.

### DETAILED DESCRIPTION

Hereinafter, exemplary embodiments of the present disclosure will be described in detail with reference to the accompanying drawings.

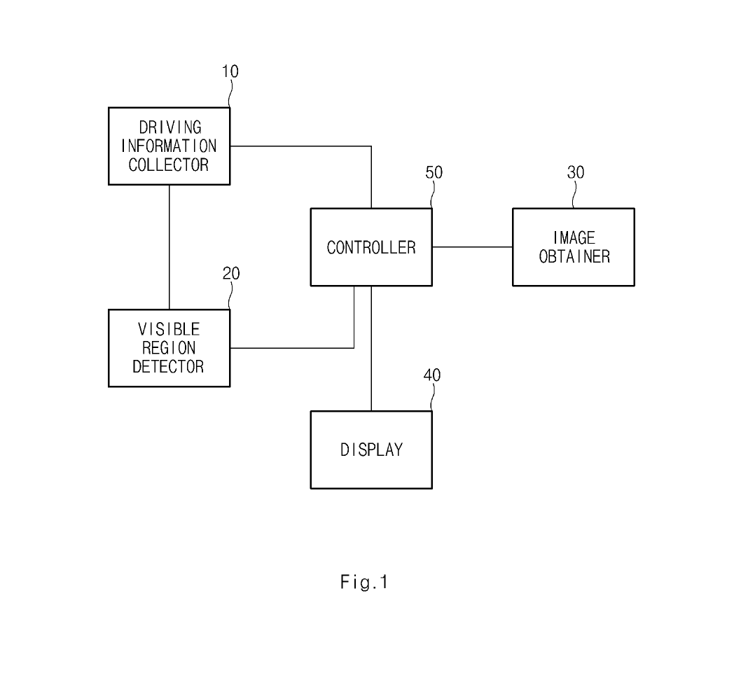

FIG. 1 is a configuration diagram of an apparatus for controlling a display of a vehicle cluster according to an exemplary embodiment of the present disclosure. As shown in FIG. 1, the apparatus for controlling a display of a vehicle cluster according to an exemplary embodiment of the present disclosure is configured to include a driving information collector 10, a visible region detector 20, an image obtainer 30, a display 40, and a controller 50.

Describing each of the components, the driving information collector 10 may collect steering angle information and gear position information through a vehicle network and collect crossroad information by interworking with navigation mounted in the vehicle. The driving information collector 10 may directly collect the steering information from a steering angle sensor.

The visible region detector 20 may detect a cluster visible region which is viewable to a driver, except for a cluster blind region blinded by a hand of the driver and a steering wheel.

The image obtainer 30 may obtain an infrared thermal image from a night vision system mounted in the vehicle, obtain a rear side image from a blind spot detection system (BSD) mounted in the vehicle, or obtain a rear image from a parking assist system (PAS), under control of the controller 50. The BSD system has cameras for photographing a blind spot at outside mirrors of both sides of the vehicle and outputting an image signal received from the camera to a display apparatus mounted in the vehicle. Thus, the driver may safely change a lane while viewing the image of the camera in real time.

The display 40 may display any one of the infrared thermal image, the rear side image, and the rear image obtained by the image obtainer 30 on the visible region detected by the visible region detector 20, under control of the controller 50. Here, the display 40 means a cluster. In addition, the display 40 may display the respective images by expanding or reducing the respective images when displaying any one of the infrared thermal image, the rear side image, and the rear image obtained by the image obtainer 30 on the visible region detected by the visible region detector 20, under control of the controller 50.

The controller 50 may perform a general control so that respective components may perform a relevant function normally. Particularly, the controller 50 may control the image obtainer to obtain an image corresponding to driving information (e.g., steering angle information, gear position information, and crossroad information) obtained by the driving information collector 10.

For example, when it is determined that the vehicle drives on a curved road through the steering angle information, the controller 50 may control the image obtainer 30 to obtain the infrared thermal image by the night vision system. In addition, when it is determined from the gear position information that the vehicle is backed, the controller 50 may control the image obtainer 30 to obtain the rear image by the PAS system. In addition, when it is determined from the crossroad information that the vehicle is driven on a crossroad, the controller 50 may control the image obtainer 30 to obtain the rear side image by the BSD system.

When the vehicle is in a reverse gear state, the controller 50 may control the image obtainer 30 to obtain the rear image while ignoring the steering angle information. In this case, considering that when the gear is shifted from a parking state to a forward gear, it passes through the reverse gear, the controller 50 may determine a reverse state when the reverse gear is maintained during a threshold time (e.g., 2 seconds) or more. In addition, when the vehicle is driven on the crossroad, the controller 50 may control the image obtainer 30 to obtain the rear side image while ignoring the steering angle information.

The controller 50 may control the display 40 to display an image corresponding to the driving information collected by the driving information collector 10 on the visible region detected by the visible region detector 20. In addition, the controller 50 may control the display 40 to expand or reduce the image displayed on the visible region depending on a head size of the driver detected by the visible region detector 20. That is, in the case in which the head size of the driver detected by the visible region detector 20 is less than a reference value, which means the driver is close to the cluster, the controller 50 may control the display 40 to reduce and display the image. In the case in which the head size of the driver detected by the visible region detector 20 is larger than the reference value, which means the driver is far away the cluster, the controller 50 may control the display 40 to expand and display the image.

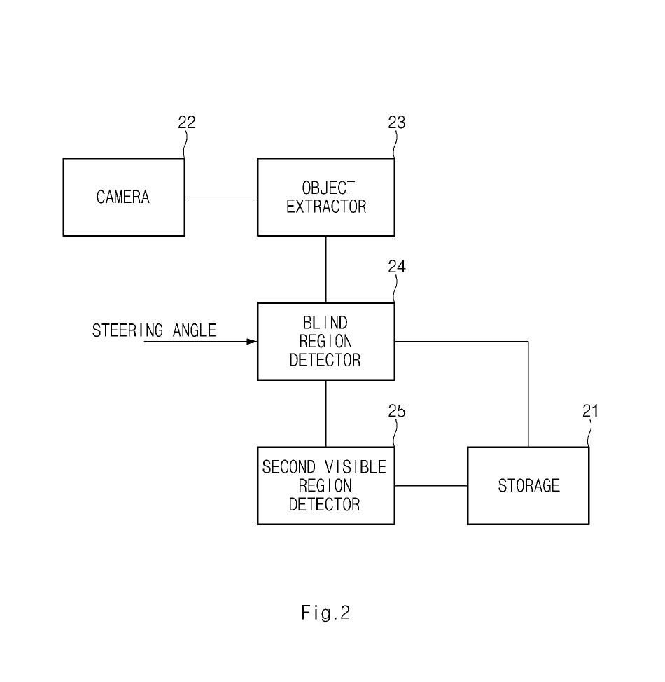

Hereinafter, a process in which the visible region detector 20 detects the visible region will be described in detail with reference to FIG. 2.

FIG. 2 is a detailed configuration diagram of a visible region detector according to an exemplary embodiment of the present disclosure. As shown in FIG. 2, the visible region detector according to an exemplary embodiment of the present disclosure is configured to include a storage 21, a camera 22, an object extractor 23, a blind region detector 24, and a second visible region detector 25.

Describing the respective components, first, the storage 21 stores a cluster blind region corresponding to a steering angle and a cluster region. Here, the cluster blind region corresponding to the steering angle, which is a coordinate section calculated by an experiment, means a cluster region in which the driver's eyes are blinded by the steering wheel depending on a change in the steering angle. The cluster region means a region (coordinate section) of a blind screen in an image which is photographed by the camera 22, in a state in which the driver completely blinds the cluster by the blind screen at a position of the steering wheel, that is, a state in which the cluster is not viewable to the driver's eyes by the blind screen.

The camera 22 is mounted on a dashboard of an upper end of the cluster and photographs the head of the driver and a portion of the steering wheel.

The object extractor 23 may extract a hand region and a head region of the driver from the image which is photographed by the camera 22. Here, since a technology of extracting the object from the image is a well-known technology, a detailed description thereof will be omitted.

The blind region detector 24 compares the cluster region which is stored in the storage 21 with the hand region of the driver extracted by the object extractor 23 to detect a primary blind region, detects a secondary blind region corresponding to the steering angle collected by the driving information collector 10 based on the cluster blind region corresponding to the steering angle which is stored in the storage 21, and then detects a final blind region by summing the primary blind region and the second blind region.

The second visible region detector 25 may detect a region in which the final blind region detected by the blind region detector 24 is subtracted from the cluster region which is stored in the storage 21, as the visible region.

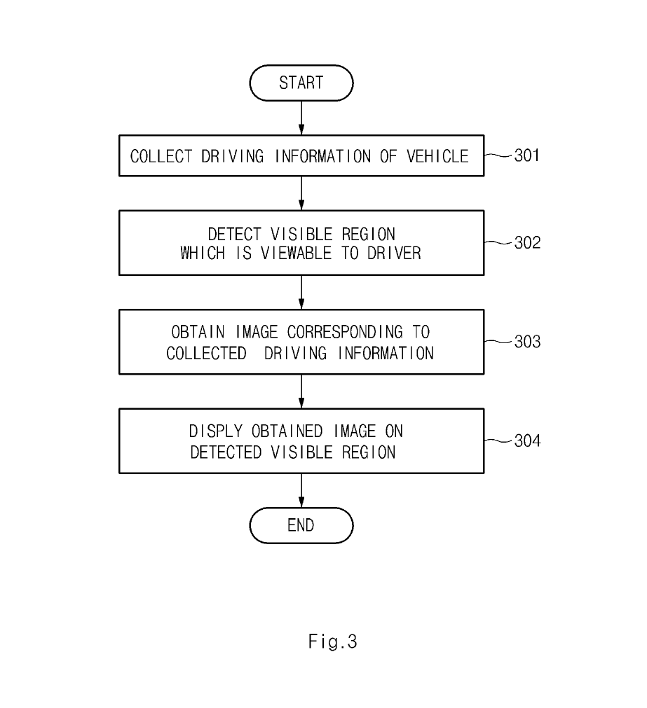

FIG. 3 is a flow chart showing a method for controlling a display of a vehicle cluster according to an exemplary embodiment of the present disclosure.

First, a driving information collector 10 collects driving information of a vehicle (301). A visible region detector 20 detects a visible region which is viewable to a driver (302). Next, an image obtainer 30 obtains an image corresponding to the driving information collected by the driving information collector 10, under control of a controller 50 (303). Then, a display 40 displays the image obtained by the image obtainer 30 on the visible region detected by the visible region detector 20, under control of the controller 50 (304).

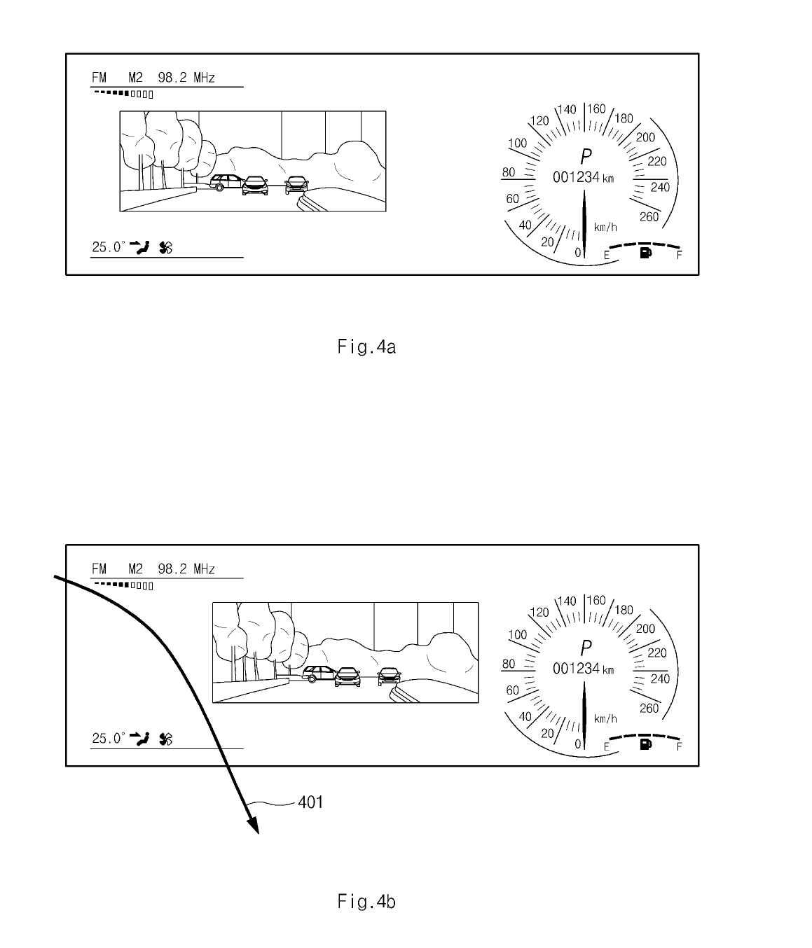

FIGS. 4A and 4B are diagrams showing displaying results of the vehicle cluster according to an exemplary embodiment of the present disclosure. FIG. 4A shows a state in which an infrared thermal image obtained from a night vision system is displayed on a cluster when a blind region is not generated. FIG. 4B shows a state in which an infrared thermal image obtained from a night vision system is displayed on a cluster when a blind region 401 is generated. In this case, if the driver turns the steering wheel to the right, the blind region 401 is generated at the left due to a rim region and a hand of the driver.

Thereby, it may be appreciated that the infrared thermal image moves to the visible region. This process is performed in real time.

According to the exemplary embodiments of the present disclosure, the apparatus for controlling the display of the vehicle cluster and the method thereof may enable the driver to view the necessary image according to the driving state of the vehicle at high visibility by detecting the cluster blind region which is blinded by the hand of the driver and the steering wheel. The necessary image is displayed according to the driving state of the vehicle on the visible region of the cluster which is viewable to the driver except for the cluster blind region.

What is claimed is:

1. An apparatus for controlling a display of a vehicle cluster, the apparatus comprising:
a driving information collector configured to collect driving information of the vehicle;
a visible region detector configured to detect a visible region which is viewable to a driver;
an image obtainer configured to obtain various images;
a display configured to display the various images obtained by the image obtainer on the visible region detected by the visible region detector; and
a controller configured to control the image obtainer to obtain an image corresponding to the driving information collected by the driving information collector and control the display to display the image corresponding to the driving information collected by the driving information collector on the visible region detected by the visible region detector.

2. The apparatus according to claim 1, wherein the driving information includes steering angle information, gear position information, and crossroad information.

3. The apparatus according to claim 2, wherein the controller controls the image obtainer to obtain a rear image when it is determined from the gear position information that the vehicle is backed, and controls the image obtainer to obtain a rear side image when it is determined from the crossroad information that the vehicle is driven on a crossroad.

4. The apparatus according to claim 3, wherein the controller controls the image obtainer to obtain an infrared thermal image when it is determined from the steering angle information that the vehicle is driven on a curved road, in a state in which the vehicle is not in a reverse state and is not driven on the crossroad.

5. The apparatus according to claim 1, wherein the visible region detector includes:
a storage configured to store a cluster blind region corresponding to a steering angle and a cluster region;
a camera disposed at an upper end of a cluster and photographing the driver;
an object extractor configured to extract a hand region and a head region of the driver from the image which is photographed by the camera;
a blind region detector configured to compare the cluster region which is stored in the storage with the hand region of the driver which is extracted by the object extractor to detect a primary blind region, detect a secondary blind region corresponding to the steering angle collected by the driving information collector based on the cluster blind region corresponding to the steering angle which is stored in the storage, and detect a final blind region by summing the primary blind region and the second blind region; and
a second visible region detector configured to detect a region in which the blind region detected by the blind region detector is subtracted from the cluster region which is stored in the storage, as a visible region.

6. The apparatus according to claim 5, wherein the controller controls the display to expand or reduce an image which is displayed on the visible region depending on a head size of the driver extracted by the object extractor.

7. A method for controlling a display of a vehicle cluster, the method comprising steps of:
collecting, by a driving information collector, driving information of the vehicle;
detecting, by a visible region detector, a visible region which is viewable to a driver;
obtaining, by an image obtainer, an image corresponding to the collected driving information; and
displaying, by a display, the obtained image on the detected visible region.

8. The method according to claim 7, wherein the driving information includes steering angle information, gear position information, and crossroad information.

9. The method according to claim 8, wherein the step of obtaining the image includes steps of:
obtaining a rear image when the gear position information represents a reverse;
obtaining a rear side image when the driving information is the crossroad information; and
obtaining an infrared thermal image when a steering angle exceeds a threshold value in a state the vehicle is not in a reverse state and is not driven on a crossroad.

10. The method according to claim 7, wherein the step of detecting the visible region includes steps of:
storing, by a storage, a cluster blind region corresponding to a steering angle and a cluster region;
photographing, by a camera positioned at an upper end of a cluster, the driver;
extracting, by an object extractor, a hand region and a head region of the driver from the photographed image;
comparing, by a blind region detector, the cluster region with the hand region of the driver to detect a primary blind region;
detecting, by the blind region detector, a secondary blind region corresponding to the steering angle collected by the driving information collector based on the cluster blind region corresponding to the steering angle;
detecting, by the blind region detector, a final blind region by summing the primary blind region and the second blind region; and
detecting, by a second visible region detector, a region in which the final blind region is subtracted from the cluster region, as a visible region.

11. The method according to claim 10, wherein in the step of displaying the image, the image which is displayed on the visible region is expanded or reduced depending on an extracted head size of the driver.
